(19) United States
(12) Patent Application Publication
(10) Pub. No.: US 2002/0022523 A1
(43) Pub. Date: Feb. 21, 2002

(54) Learning/growing system using living goods and method thereof

(75) Inventors: Byung Ju Dan, Sungnam (KR); Jong Rak Lim, Yongln (KR); Jae Ho Na, Kuri (KR); Jang Won Boo, Seoul (KR); Hee Il Wang, Seoul (KR); Nam Woong Kim, Seoul (KR); In Sang Song, Ulwang (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/931,349

(22) Filed: Aug. 16, 2001

(30) Foreign Application Priority Data
Aug. 17, 2000 (KR) 2000-47555
Aug. 17, 2000 (KR) 2000-47556

(51) Int. Cl. G06F 19/00

(52) U.S. Cl. 463/42

(57) ABSTRACT

A learning/growing system of a toy using real living goods to solve problems of conventional art, that is, that the method of conventional art is too simple and related to real life little, whereby the growing of the toy is monotonous and the user can not be interested in the toy continuously, comprises a learning/growing toy expressing desires for eating, learning, and playing at a certain time point, and grown intellectually and physically by being inputted products and goods information corresponding to satisfaction of the desires; a personal computer for downloading the goods information for satisfying the desires of the toy and inputting the information into the learning/growing toy; and a web server recognizing the desire generations of the toy and including advertising banners for various products of many companies and detailed information according to the banners. Therefore, the toy is learned/grown by inputting names or barcodes of various living goods such as food and service items, whereby it induces higher interest and attachment.

### BACKGROUND OF THE INVENTION

1. Field of the Invention

The present invention relates to a system for learning/growing a toy using living goods, and particularly, to a learning/growing system using living goods and a method thereof by which a toy can be satisfied desires for eating, learning, and for playing by clicking names of the living goods or corresponding barcodes by a user through banners for advertising and detailed information supplied on a web server, whereby the toy is learned and grown.

2. Description of the Background Art

Recently, a technique for growing a game character through a growing simulation game is distributed usually, and a toy having abilities of learning and of growing is developed, whereby the market for the toys is enlarged gradually. For an example of the learning/growing toy, there are provided such as virtual pets or virtual plants. The toys such as above are bred and grown on-line network through the internet. The user of the toy is able to control the appearance, act, and change of the virtual pet or plants according to the time, and control the virtual pets or plants as he/she likes by selecting some characteristics of the pets or plants. Recently, toys of dogs, cats, birds, and fishes are developed, and the toys are able to be learned and grown by the user (purchaser) of the toys.

The toys of interactive mode such as Poo-chis, Robo-toys, and Robo-pets are able to be learned/grown by controlling keys on a remote controller or by using a voice recognition technique. For example, the Robo-dog is programmed so as to response to a voice order, to sing a song, and to play by training of the user. In addition, the degree of interaction between the user and the toy affects greatly to the growth and controlling of the toy. Elements which affect to the growth and controlling of the toy are such as the number of charge the toy since the date of buying, the number of sensor's reactions, and the number of training the voice recognition. And the toy is intellectually and physically grown according to learning/growing by the user for a certain period.

However, in the conventional art, the method for learning/growing the toy is very simple and has little relationship with the real life, and therefore the growth of the toy is lack of variety and it can not induce interest of the user continually.

### SUMMARY OF THE INVENTION

Therefore, an object of the present invention is to provide a learning/growing system using living goods and a method thereof by which a toy is learned and grown by being recognized names or barcodes of various living goods.

In addition, an objects of the present invention is to provide a learning/growing system using living goods and a method thereof which makes the toy be learned/grown by using various banner ads related to the food, studying, and playing supplied by the web server.

It is another object of the present invention to induce interests of user through improved learning/growing process using web server.

The toy according to the present invention can be connected directly to the internet through a communication port, therefore the user is able to input desires of the toy to the web server without connecting to the user computer. Consequently, the user is able to download goods for satisfying the desires and related detailed information.

Additional features and advantages of the invention will be set forth in the description which follows, and in part will be apparent from the description, or may be learned by practice of the invention. The objectives and other advantages of the present invention will be realized and attained by the structure particularly pointed out in the written description and claims hereof as well as the appended drawings.

To achieve these and other advantages and in accordance with the purpose of the present invention, as embodied and broadly described herein, there is provided a learning/growing system using living goods according to the present invention comprising: a learning/growing toy which is learned/grown intellectually and physically by being inputted goods and related information corresponding to the respective desires, after expressing desires such as appetite for eat, studying, and for playing at a certain time; a personal computer for downloading information satisfying the desires of the toy from a web server, and outputting the information into the learning/growing toy; and the web server having a plurality of banner ads for variety of goods and related detailed information, and recognizing desire generation of the toy.

To achieve these objects of the present invention, there is also provided a learning/growing method using living goods according to the present invention comprising the steps of: expressing the desires; inputting the expressed desires to a web server through a user computer; downloading banner goods for advertising to the user computer; selecting the banners for ads by the user; recognizing the result of selecting banner, and inputting the goods corresponding to the result into the toy through the user computer; and learning/growing the toy by being inputted the goods.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic overview diagram of the network computing environment in which the preferred embodiments are implemented;

FIG. 2 illustrates software components in the web server in accordance with the preferred embodiments of the present invention;

FIG. 3 is a block diagram showing the learning/growing system using the web server according to the present invention;

FIG. 4 is a detailed diagram of a learning/growing toy;

FIG. 5 is a detailed block diagram showing the performance unit in FIG. 4;

FIG. 6 is a flow chart of operation for the learning/growing method using living goods according to the present invention;

FIG. 7 illustrates an embodiment showing generation of learning/growing desire of the toy according to the present invention;

FIG. 8 illustrates an embodiment of banner database according to the present invention;

FIG. 9 illustrates an embodiment of goods information database according to the present invention;

FIG. 10 illustrates another embodiment of recording the goods information on a storing medium of the learning/growing toy;

FIG. 11 illustrates still another embodiment of recording the goods information on the storing medium of the learning/growing toy; and

FIG. 12 illustrates still another embodiment of recording the goods information on the storing medium of the learning/growing toy.

### DETAILED DESCRIPTION OF THE PREFERRED EMBODIMENTS

Reference will now be made in detail to the preferred embodiments of the present invention, examples of which are illustrated in the accompanying drawings.

The preferred embodiments are directed to advertising banners about food, learning, and playing supplied on the web server, to bar codes of respective living goods and service goods, to reactions of the toy after recognizing the goods, and to a valid period of the goods for real learning/growing of the toy through an internet communication network after a user purchase the toy.

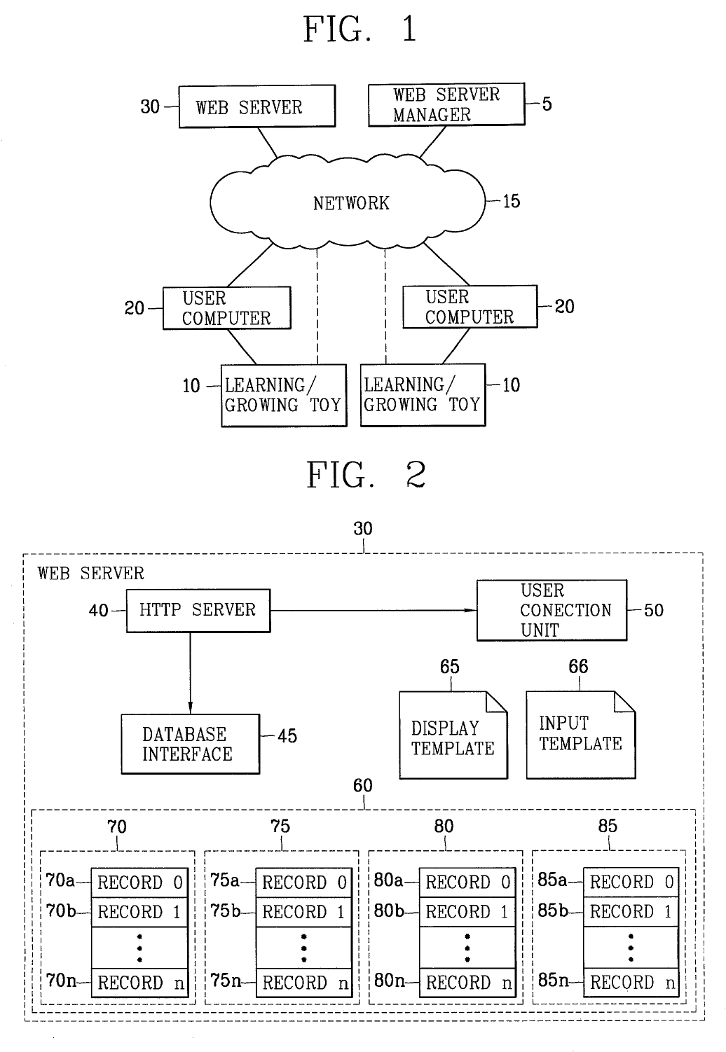

FIG. 1 is a schematic overview diagram of the network computing environment in which the preferred embodiments are implemented. In preferred embodiments, a user computer 20 can access a web server 30 using a network 15. The network 15 may be comprised of any network system known in the art including TCP/IP based networks (e.g., an Intranet, or the Internet), LAN (Local Area Network), Ethernet, WAN, Token Ring, etc. Further, because the preferred embodiment of the network 15 is the internet, there can be numerous users using the network 15 simultaneously, however only two user computers 20 are shown for illustration purposes. A learning/growing toy 10 can be directly connected to the user computers 20 by means of a communication port, such as a serial port, parallel port or USB (Universal Serial Bus) connection or other suitable communication means.

However, in another embodiment, the learning/growing toy 10 may connect to network 15 by means of a wireless internet connection avoiding the user of the user computers 20. In addition, the network 15 also connects the web server 30 to the web server 30 and a web server manager 5 in the toy manufacturing company, whereby the web server 30 can deliver desire generation of the learning/growing toy 10 to the web server manager 5.

FIG. 2 illustrates software components in the preferred embodiment of the web server 30, including a HTTP (Hypertext Transfer Protocol) server 40, a database interface 45, and a display template 65 and input template 66. The HTTP server 40 responds to requests from the user computers 20 using HTTP client programs, such as web browser programs known in the art. Upon accessing the HTTP server 40 through the network 15 using a certain network address (IP address), the database interface 45 will give specific access to certain parts of database table storing unit 60 depending on the secured identification provided by the user computer 20 (e.g., certain username, toy name, identification number, password, etc).

The database table storing unit 60 keeps current information about users of the learning/growing toy 10, the learning/growing toy 10 itself, and variety of other information needed to provide information throughout the website. The database table storing unit 60 comprises a database program known in the art, such as a related database program, and four database table 70, 75, 80 and 85. In the preferred embodiment, a user database table 70, which includes addresses 70a, 70b, . . . , 70n storing user records 0, 1, . . . , n respectively, is used in order to track user information. The respective addresses 70a, 70b, ., 70n store unique purchaser information about various users. In fields within the addresses 70a, 70b, . . . , 70n, information such as user name, password, credit card information, address, user's tastes and preferences, purchase record, etc. is stored.

Also, a manual database table 75 includes addresses 75a, 75b, . . . , 75n which are used in the preferred embodiment to keep generic information about the website, instructions to the web server 30, and introductory information about the learning/growing toy 10.

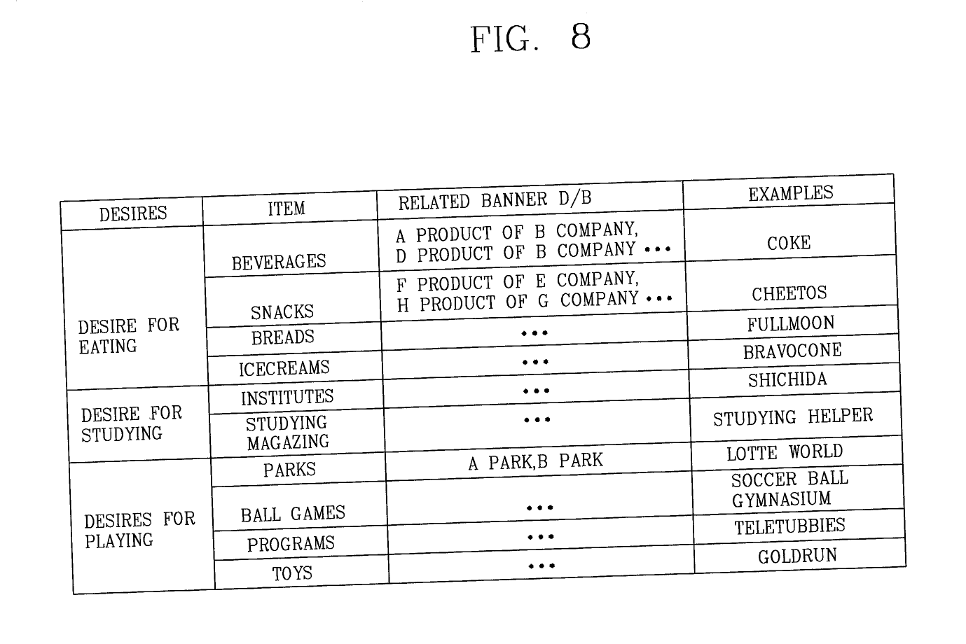

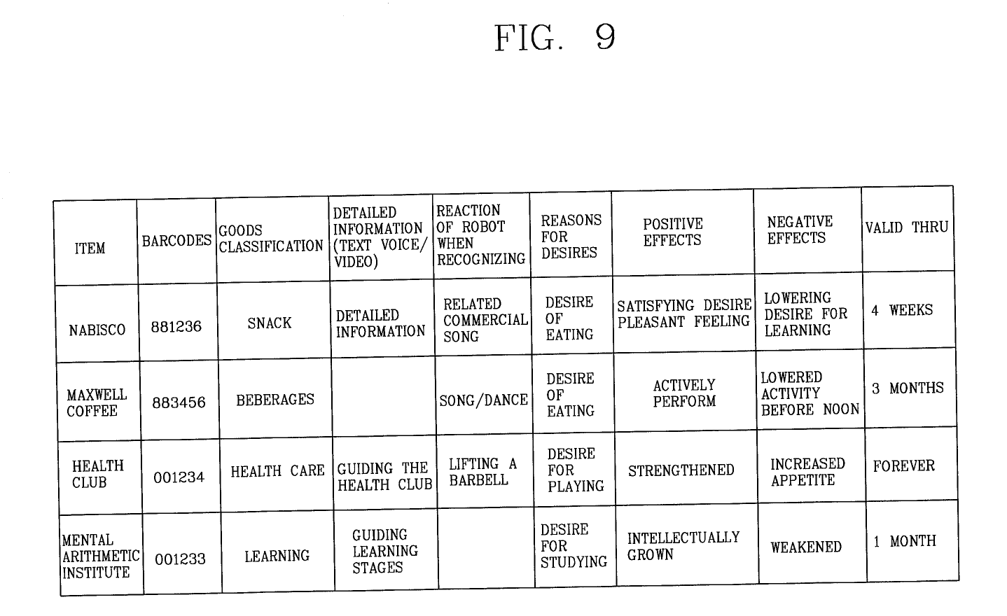

Also, a banner database table 80 includes addresses 80a, 80b, . . . , 80n, and stores various items for satisfying desires of the learning/growing toy 10, that is, desires for eating, learning, and playing and advertising banners for the items. A goods information database table 85 includes addresses 85a, 85b, . . . , 85n stores detailed information about the goods includes in the advertising banners stored in the banner database table 80, such as barcodes of the goods, various responses of the learning/growing toy 10 after it recognized the goods, reasons of the desires, and validity terms. In addition, the banner database table 80 and the goods information database table 85 are will be described in more detail in FIGS. 8 and 9.

The database interface 45 may comprise a CGI (Common Gateway Interface) program, a Java servlet, or other web page implementation known in the art to present the information in database table storing unit 60 in a presentable format (e.g., HTML page, etc.). In preferred embodiments, the database interface 45 uses a secured login/password verification for identifying the individual user contacting the HTTP server 40. The assigning of a secured login/password can occur when the user purchases an learning/growing toy, visits the website. The unique identification will allow the database interface 45 to identify which address among 75a, 75b, . . . , 75n belongs to the requesting party and will appropriately give read/write capabilities to the addresses 75a, 75b, . . . , 75n.

Also, the server 20 further stores a display template 65 and an input template 66. Herein, the display template 65 and the input template 66 are preferably implemented in a document in which dynamic content may be generated (HTML, XML (Extended Markup Language) Document, etc.). Differing variations of the display template 65 and input template 66 exists for both user information and the learning/growing toys, depending on the information to be displayed or inputted. However, a single display template 65 and a single input template 66 are used for illustration purposes in FIG. 2. The display template 65 is used to provide the user computer 20 with specific user and toy information from the database tables 70, 75, 80 and 85. The database interface 45 fetches data stored in the addresses 70a, 70b, . . . , 70n, 75a, 75b, . . . , 75n, 80a, 80b, . . . , 80n 85a, 85b, . . . , 85n in the database table storing unit 60 to the display template 65. The web server 30 collects data from the users or toys using the input template 66, and stored the collected information in one or more addresses 70a, 70b, . . . , 70n, 75a, 75b, . . . , 75n, 80a, 80b, . . . , 80n 85a, 85b, . . . , 85n stored in the database table storing unit 60.

The database table storing unit 60, the display template 65, and the input template 66 are preferably stored in a non-volatile storage system, such as on or more hard disk drives, used by the server 30 for storage. The web server 30 may load data from the storage system into volatile memory (not shown) when processing.

The web server 30, the web server manager 5, and the user computer 20 may be organized computer devices known in the art including a server, a personal computer, a main frame, a workstation, a hand held PC, etc. In addition, the web server 30 may further comprise one or more separated computer system in order to operate the different program components, such as the HTTP server 40, the database interface 45, and the database table storing unit 60.

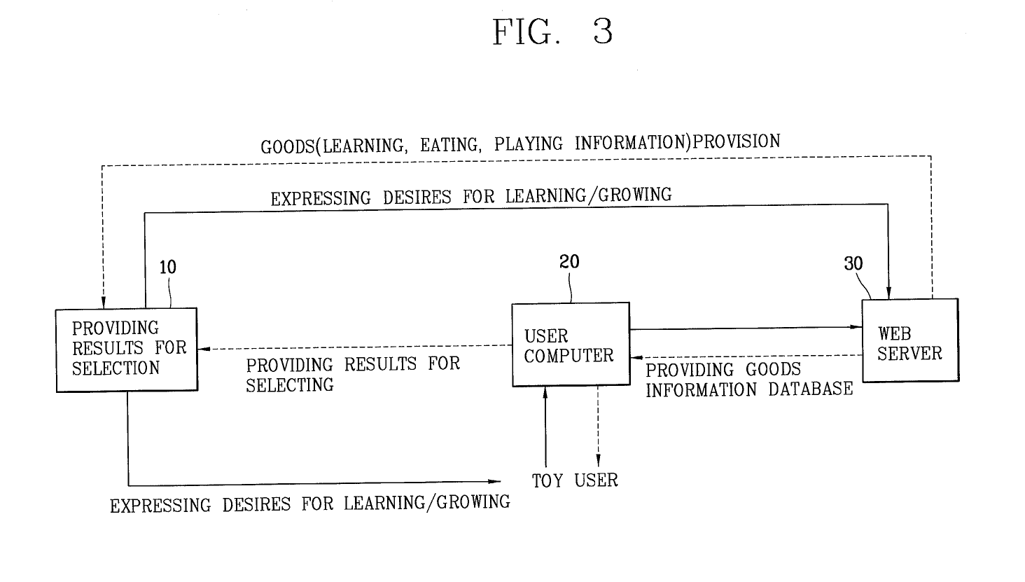

FIG. 3 is a block diagram showing the learning/growing system using living goods according to the present invention comprising: a learning/growing toy 10 expressing desires for eating, learning, and playing at a certain time, and after that learned/grown intellectually and physically by being inputted goods corresponding to the respective desires; a personal computer 30 downloading goods information for satisfying the desires from the web server 30 and inputting the information into the learning/growing toy 10; a web server 30 identifying the generation of desires of the learning/growing toy 10, and including a banner database table 80 memorizes advertising banners and the goods information database table 85 which memorizes goods information such as detailed information about the banners and barcodes, reactions of the toy when recognizing the goods, a style of action, reasons for the desires, and degrees of effect to the learning/growing of the toy (actions, characteristics, feeling, intelligence, and desires, etc.).

The learning/growing system using living goods and the method thereof according to the present invention will be described in more detail.

The web server manager 5 organizes the banner database table 80 memorizing the advertising banners for products and goods of various companies, and goods information database table 85 memorizing barcodes of respective living goods and service items, reactions and styles of action of the toy after recognizing the goods, reasons for generation of desires, the validity terms of the goods, and degrees of effects to the learning/growing of the toy (actions, characteristics, feeling, intelligence, and desires, etc.), registers the corresponding data on the web server 30, and updates the banner database and the goods information database continuously.

As described above, the banner database table 80 and the goods information database table 85 are shown in FIG. 2.

The learning/growing toy 10 expresses desires for eating, learning, and playing in accordance with learning/growing as various formats. At that time, the learning/growing toy 10 may express the various desires as in motion, voice, and letters form to the user, or may express the desires to the web server 30 regularly or irregularly by including a communication means such as a serial port, a parallel port, an USB, and a wireless internet.

After that, the user of the toy recognizes the desires through the motion, voice, and letters of the learning/growing toy 10, and connects to the web server 30 through the user computer on the internet. At that time, the web server 30 searches the identification number of the user presently connected to the server, the identification number of the toy, or user information through the user connecting unit 50, and after that refers the purchasing time of the toy and data corresponding to the learning/growing before, at the same time, recognizes desire information of the learning/growing toy 10.

After that, the web server 30 displays the data of the advertising banners of various items corresponding to the learning/growing degree and desire expressing degree of the learning/growing toy 10 from the banner database table 80, and the data of barcodes of respective living goods and service items, reactions and the style of action of the toy after recognizing the goods, reasons for desires, the validity terms of the goods, and degrees of effects to the learning/growing of the toy (actions, characteristics, feeling, intelligence, and desires, etc.) on the user computer 20.

The user selects any advertising banner among various banners displayed on the screen of the user computer 20. At that time, if the learning/growing toy 10 directly inputs the desire information to the web server 30 through the communication port, the web server 30 records the banner database and the good information database in the goods information storing medium of the learning/growing toy 10, and displays it through an outputting means, and then the user recognizes it.

Herein, the outputting means of the learning/growing toy 10 may be LCD (Liquid Crystal Display), LED (Light Emitting Diode), and monitor, etc. After that, when the user selects a certain banner among the advertising banners, the outputting means displays goods information of various companies and detailed information thereof, and the learning/growing toy 10 grows for a certain period by the user or by itself.

Therefore, the web server manager 5 serves information such as barcodes of respective living goods and service items, reactions and the style of action of the toy after recognizing the goods, reasons for desires, the validity terms of the goods, and degrees of effects to the learning/growing of the toy (actions, characteristics, feeling, intelligence, and desires, etc.) in the goods information database, as well as the goods information according to the advertising banner in the banner database to the user, whereby the toy is learned/grown more intellectually and physically, and the user can feel more interests.

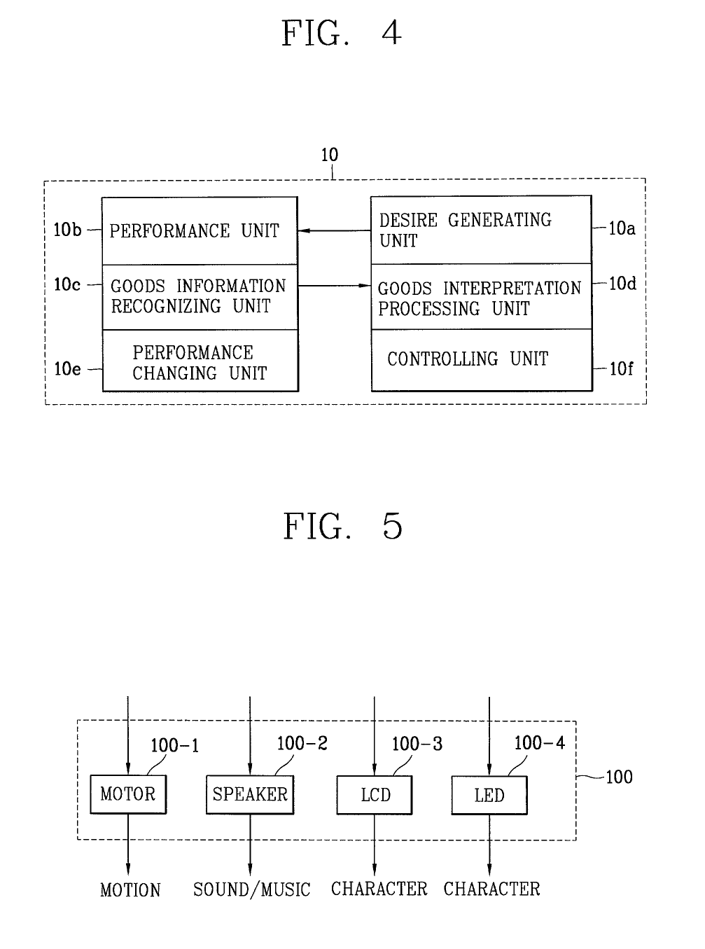

FIG. 4 is a detailed view of the learning/growing toy in FIG. 3.

The learning/growing toy 10 according to the present invention comprises: a desire generation unit 10a for outputting signals according to the desires for eating, learning, and playing; a performance unit 10b being inputted the signals according to the desires and outputting the signals as motion, voice, video, and light forms using a motor, a speaker, an LCD, and an LED etc.; a goods information recognizing unit 10c for recognizing goods information such as name, barcodes, and item classification provided by the web server 30 or the user using devices such as a barcode scanner, a CCD (Charge-Coupled Device) camera, a microphone, and a keyboard in order to satisfy the desires of the learning/growing toy; a goods interpreting processing unit 14 for judging the goods provided to the learning/growing toy by analyzing/processing the goods information of video, voice, letter forms recognized through the good information recognizing unit 10c; a control changing unit 10e for recognizing the various goods provided by the web server 30 and changing a controlling pattern so that the controlling operations of learning/growing according to the goods selected by the user; and a controlling unit 10f totally controlling the learning/growing toy.

The operation of the learning/growing toy 10 as above will be described as follows.

The desire generation unit 10a generates signals according to the desires for eating, learning, and playing by itself, or generates desires as the format prestored in the database table storing unit 60 of the web server 30. At that time, the controlling unit 10f inputs the desire expressing signal into the performance unit 10b, and the performance unit 10b expresses the desires through the desire expressing signal. An implement for desire generation according to the learning/growing of the learning/growing toy 10 will be described in FIG. 5.

The web server 30 is inputted the desires of the learning/growing toy 10 through the user computer 20, or inputted directly through the communication means of the learning/growing toy 10.

After that, the user connecting unit 50 of the web server 30 compares/identifies the user information (name of the user, password, credit card number, address, preferences of the user, and purchase records, etc.) with the user information of the user of the toy, and after that, downloads information about the advertising banners of various items and goods information such as barcodes of the banner or detailed information, reactions of the toy when recognizing the goods, styles of the action, reasons for desires, and degrees of effects to the learning/growing of the toy (actions, characteristics, feeling, intelligence, and desires, etc.) from the banner database table 80 or from the goods information database table 85 to the user computer 20, and display it on screen.

After that, the goods information recognizing unit 10c is inputted the goods information such as barcodes or names of the goods according to the advertising banner inputted from the web server 30, and judges the goods by analyzing/processing the inputted goods information.

The control changing unit 10e recognizes the various goods information provided by the web server 30, and after that, changes the controlling patterns so that the controlling operations of learning/growing is performed according to the selected goods for satisfying the desires of the learning/growing toy 10. As an example of the controlling operation in accordance with the learning/growing, when the learning/growing toy 10 eats or gets the corresponding products or service items in order to satisfy the desires, the toy may sing the CM song corresponding to the goods or may imitate the model of the advertisement.

FIG. 5 is a detailed block diagram showing the performance unit in FIG. 4. As shown therein, the performance unit 10b of the learning/growing toy 10 includes a motor 10c-1, a speaker 10c-2, an LCD 10c-3, and an LED 10c-4, etc. For example, the controlling unit 10f in FIG. 4 controls the driving of the motor 10c-1, whereby the toy may express a certain motion about the desires, may express as a sound or voice through the speaker 10c-2, or may express the desire as letters through the LCD 10c-3 or through the LED 10c-4, when the toy expresses a desire according to the generation of the desire.

Herein, the style and means for expressing desires of the toy are not limited to the above description, and it may be changed using ordinary skill in the art.

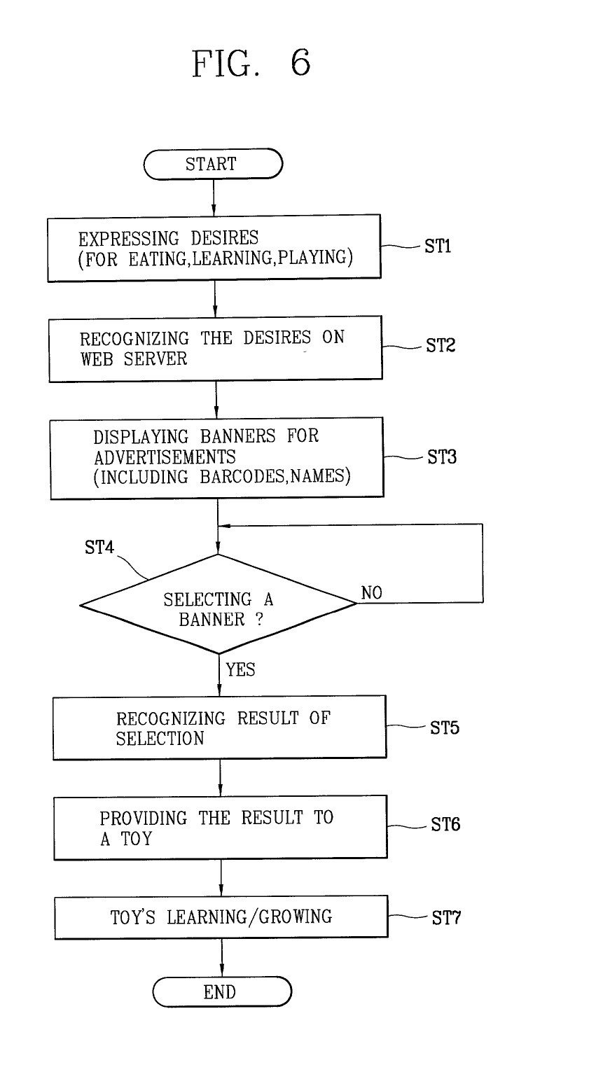

FIG. 6 is a flow chart of the operation for the toy learning/growing method using living goods according to the present invention.

The learning/growing toy 10 expresses desires for eating, learning, and playing through the desire expressing means in FIG. 5 (ST1). The user of the toy transmits the signals for the desires of the learning/growing toy 10 to the web server 30 through the user computer 20. Accordingly, the web server 30 recognizes the detailed desires of the learning/growing toy 10 (ST2). The web server 30 provides advertising banners according to various goods information for satisfying the desires of the learning/growing toy 10 and detailed information to the user computer 20, and display the data on a screen (ST3). After that, the web server 30 asks the user whether he/she selects a banner item or not (ST4). Then the user selects a banner item corresponding to satisfaction of the desires of the learning/growing toy 10 with reference to the goods information database in the goods information database table 85 provided by the web server 30.

However, if the user does not want to choose a banner, the web server 30 stores the desire information of the learning/growing toy 10 in an inner memory (not shown), and then waits. After a certain period is passed, when another desire of the learning/growing toy 10 is expressed, the desire is displayed with earlier desires on the user computer 20.

When the user chooses a banner item, the web server 30 recognizes that (ST5), and after that provides the goods in accordance with the choice of the user to the learning/growing toy 10 directly or through the user computer 20 (ST6). After that, the learning/growing toy 10 eats or gets the goods for satisfying the desires, whereby the toy is grown physically or intellectually.

In the learning/growing method described above, the web server 30 may provide barcodes or names of real products (for example, snacks, beverages, athletic goods, software programs for studying, etc.) to the goods information recognizing unit 10c of the learning/growing toy 10, without inputting the goods information to the learning/growing toy through the user computer 20. The method will be described as follows.

The goods information recognizing unit 10c is inputted the goods information such as barcodes or names of the goods according to the advertising banners selected by the user, and then scans it through a barcode reader or CCD camera installed outside of the toy 10. In addition, the goods information recognizing unit 10c abstracts the goods codes for respective goods, then the goods interpreting processing unit 10d analyzes and processes the abstracted codes and judges the goods.

After the judgement, if the goods code recognized in the goods interpreting processing unit 10d is judged not to exist in the banner database table 80, the goods is registered on the banner database table 80, and then returned.

However, if the goods codes is judged to exist in the banner database table 80, the learning/growing toy generates motions or sound according to the information about the reactions after eating or getting the corresponding goods from the goods information database table 85.

As described above, the learning/growing toy 10 recognizes the barcodes and names of respective goods through the processes, and after that controls the parameter values corresponding to the learning/growing, whereby the toy is grown.

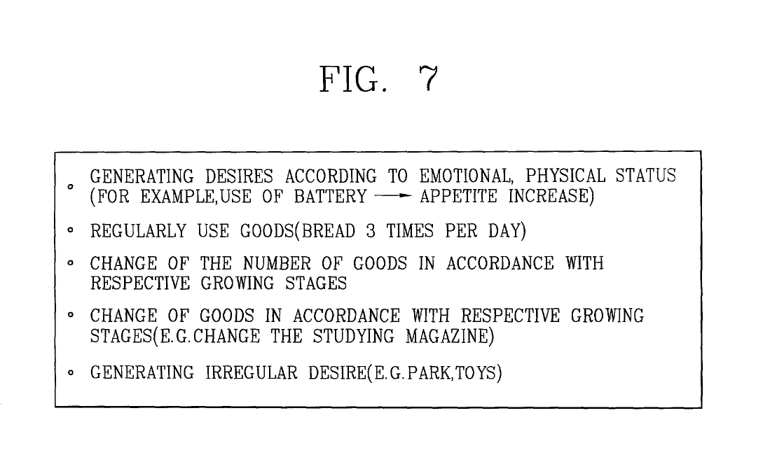

FIG. 7 shows an embodiment of learning/growing desire generation of the learning/growing toy according to the present invention.

As shown therein, there may be desires such as desires in accordance with emotional or physical status (for example, increasing appetite according to usage of the battery), desire generated for respective goods such as requiring bread three times per day, learning desire requiring studying magazines couple of times a day, and playing desire requiring a toy or to go to a park irregularly. Herein, the examples of desires are not limited to the above description, and the web server manager or the user can set the generations of desires.

FIG. 8 shows an embodiment of the banner database according to the present invention.

As shown therein, the contents written in the table are stored in the banner database table 80 in FIG. 2, and the contents can be updates by the user or by the web server manager 5 continuously.

The items for satisfying the desire for eating of the learning/growing toy 10 are such as beverages, snacks, bread, or ice creams, etc., and there may be a variety of goods of many companies. For example, in case of Coke in the beverages, it can be one of among A product of B company, and D product of C company, etc.

Also, as items for satisfying the desire for studying, there may be academic institutes, and studying magazines such as study helper.

Also, as items for satisfying the desire for playing, there may be parks such as A park and B park, ball games such as a soccer ball gymnasium, broadcasting programs such as teletubbies, and toys such as goldrun.

Therefore, the advertising banners of various items provided from the web server 30 are displayed on the screen of the user computer 20, and then the user chooses (clicks) a certain banner among those various banners displayed on the screen. For example, when the toy 10 expresses thirsty, the user clicks the banner for advertising a beverage. At that time, the web server 30 recognizes the result of user's choice, and after that, transmits the goods according to the learning/growing toy 10 through the user computer 20, or directly to the learning/growing toy 10.

FIG. 9 shown an embodiment of the goods information database according to the present invention.

As shown therein, the contents written in the table are stored in the goods information database table 85 in FIG. 2, the contents are able to be updated by the user or by the web server manager 5 continuously.

The goods information database in the goods information database table 85 is able to serve barcodes of the banner or detailed information, reactions of the toy when recognizing the goods, style of the action, reasons for desires, and degrees of effects to the learning/growing of the toy (actions, characteristics, feeling, intelligence, and desires, etc.), as well as the goods information according to the advertising banners in the banner database to the user.

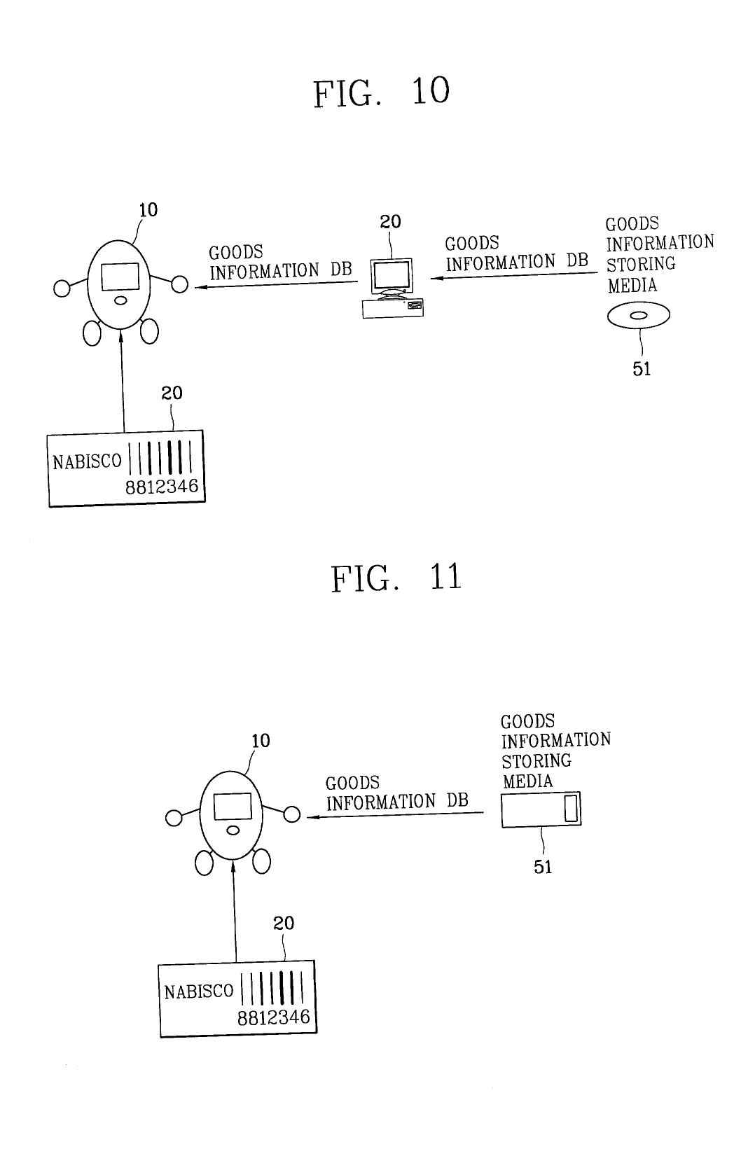

When a certain goods in the banner database table 80 in FIG. 10 is inputted into the learning/growing toy 10, it may affect to the learning/growing toy 10 as a certain degree for a certain period.

For example, after the learning/growing toy 10 recognized goods of snacks, the toy 10 is satisfied its desire for eating for a certain period (4 weeks) and has pleasant feeling, however the desire for learning is lowered, whereby learning/growing toy 10 performs foolish motions, for example, inaccurate pronunciation or unnatural movement. Also, after recognizing goods such as coffee, the toy acts lively for a certain period (3 months) however the activity is lowered before noon. Also, when the toy recognizes the goods such as health care center, the toy is greatly active without time limit, and the desire for eating is increased. In addition, when the toy 10 recognizes the goods such as mental arithmetic institute, the intelligence is increased for a certain period (1 month), and some results of simple mathematical expressions are outputted through the LCD or LED, but the toy is weakened.

The above examples are able to be updated by the user or by the web server manager 5 continuously using ordinary skills in the art, and the toy can be programmed to perform friendly to human beings in accordance with development of the art.

In the learning/growing system using living goods according to the present invention, through the processes above, the goods recognized by the learning/growing toy 10 and the number of recognition, the number of downloads, and information about unregistered goods which are not registered in the goods information database table 85 as the result of recognition are stored in the information storing medium of the learning/growing toy 10, and after that, these are feedback to the web server 30. Therefore, the seller and the advertising agent of the learning/growing toy 10 is able to know that how many advertisements are recognized by the toy 10, that is, how many goods are sold to the user, whereby the data can be used as information for the marketing.

After that, the web server manager 5 requires appropriate money to the seller or to the advertisement agent according to the contribution degrees of goods for growing of the learning/growing toy 10, responses of the learning/growing toy 10 for the respective goods, style of actions, and the validity terms.

In the descriptions above, the user directly recognizes and records the real goods through the barcode reader and CCD camera installed outside of the learning/growing toy 10.

However, as another embodiment of the system and method, the learning/growing toy may be inputted the names of respective goods by voice through microphone, by controlling buttons or a touch screen installed, or by using remote controller or keyboards from outside.

FIG. 10 shows another embodiment of the recording goods information on the storing medium of the learning/growing toy. As shown therein, the goods information is stored in a goods information storing medium 51 such as a CD (Compact Disc) without using the web server 30, and after that, the goods information is recorded in the storing medium of the learning/growing toy 10 through the user computer 20.

FIG. 11 shows still another embodiment of recording the goods information in the storing medium of the learning/growing toy 10. As shown therein, the goods information is stored in a goods information storing medium as flash memory form, and after that the goods information is recorded in the goods information storing medium 51 of the learning/growing toy 10 using the flash memory.

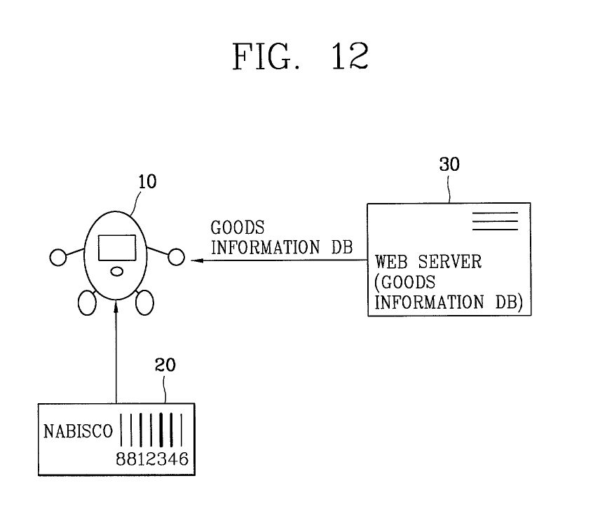

FIG. 12 shown still another embodiment of recording the goods information in the storing medium of the learning/growing toy 10. As shown therein, the storing medium is not installed inside the learning/growing toy 10, but the user connects to the web server 30 directly when needed and uses the goods information in the web server 30. Of course, in this case, a communication device by which the toy can be connected to the web server 30 should be installed on the learning/growing toy 10.

The goods recognition and reactions of the learning/growing toy 10 will be described in more detail as follows.

When the learning/growing toy 10 expresses the desire for eating through the desire outputting means in FIG. 2, the user makes the learning/growing toy 10 recognize the barcode 20A recorded on a package 20 of a snack (for example, nabisco) through the CCD camera. Accordingly, the learning/growing toy 10 acts as if it eats the snack actually, and expresses the satisfaction. As described above, when the learning/growing toy 10 recognizes the snack, the learning/growing toy 10 sings the CM songs of the goods.

However, if the toy is recognized food too often by the user, the learning/growing toy 10 acts unusually. In that case, the user may cure the toy by making the toy 10 recognize medicine such as aspirin.

As another embodiment of the present invention, the user inputs a new released music CD into the learning/growing toy 10, and then the information about the CD is displayed. And if the toy 10 is in pre-set status (for example, the toy is full and pleasant), the title of the music CD is played.

As another embodiment of the present invention, the learning/growing toy 10 recognizes barcodes attached on circumferential things by itself using the CCD camera, and acts according to that.

As still another embodiment of the present invention, the user can choose the products or barcodes of the wanted goods according to the user's taste, whereby the learning/growing toy 10 can be grown.

As described above, the toy 10 is grown by being recognized names or barcodes of the foods, respective living goods and service items, and thereby the user can be interested continuously and has higher attachment to the toy 10.

Also, a new advertising market and benefits can be formed with its certain advertisement effects.

In addition, a new business model which includes online and offline businesses both can be made by attracting various advertising banners of many companies.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A learning/growing system using living goods comprising:
a learning/growing toy which expresses desires for eating, learning, and playing at a certain time point, and after that is learned/grown intellectually and physically by being inputted products and goods information corresponding to satisfaction of the desires;
a personal computer for downloading the goods information for satisfying the desires of the toy from a web server and inputting the information into the learning/growing toy; and
a web server recognizing the desire generations of the toy and memorizing advertising banners for goods of various companies and detailed information thereof.

2. The system of claim 1, wherein the web server comprises:
a banner database table memorizing advertising banners for various goods for recognizing the desire generation of the learning/growing toy; and
a goods information database table memorizing goods information such as detailed information or barcodes for the advertising banners, reactions of the toy when recognizing the goods, style of action, reasons for the desires, and degrees of effects to the learning/growing of the toy.

3. A learning/growing system using living goods comprising:
a learning/growing toy which expresses desires for eating, learning, and playing at a certain time point, and after that is learned/grown intellectually and physically by being inputted products and goods information corresponding to satisfaction of the desires;
a personal computer for downloading the goods information for satisfying the desires of the toy from a web server and inputting the information into the learning/growing toy; and
a web server including a banner database table memorizing advertising banners for various goods for recognizing the desire generation of the learning/growing toy, and a goods information database table memorizing goods information such as detailed information or barcodes for the advertising banners, reactions of the toy when recognizing the goods, style of action, reasons for the desires, and degrees of effects to the learning/growing of the toy.

4. The system of claim 2, wherein the banner database table and the goods information database table are updated by a toy user or by a web server manager continuously.

5. The system of claim 1, wherein the learning/growing toy comprises:
a desire generating unit for outputting signals in accordance with the desires for eating, learning, and playing of the learning/growing toy;
a performance unit being inputted the signals, and expressing the desires directly to the user or the web server;
a goods information recognizing unit for recognizing goods information such as names of the goods, barcodes, and goods classifications provided by the web server or by the user using devices such as a barcode scanner, a CCD camera, a microphone, and a keyboard;
a goods interpreting processing unit for judging the goods provided to the learning/growing toy by analyzing/processing the goods information of video or voice form recognized through the goods information recognizing unit;
a control changing unit recognizing the various goods provided by the web server, and changing controlling patterns so that controlling operations of learning/growing can be performed according to the goods chosen by the user; and
a controlling unit totally controlling the learning/growing toy.

6. The system of claim 5, wherein the performance unit includes desire outputting devices of the learning/growing toy such as a motor, a speaker, an LCD, and an LED.

7. The system of claim 1, wherein the learning/growing toy is transmitted the goods information from the web server using a communication device as needed without installing a goods information storing medium therein.

8. The system of claim 1, wherein the learning/growing toy is set to imitate a certain motion, voice, or music outputted from the advertising banner.

9. The system of claim 1, wherein the learning/growing toy includes a communication means for outputting the desire information to the web server regularly or irregularly without using the user computer.

10. The system of claim 9, wherein the communication means is one of serial port, parallel port, USB, and wireless internet.

11. The system of claim 1, wherein the learning/growing toy includes a barcode scanner and a CCD camera for being inputted the names or barcodes of real goods directly by the user without being inputted the goods for banner from the web server.

12. The system of claim 1, wherein the web server comprises:
a user database table for storing information such as name of the user, password, credit card number, address, taste and preferences of the user, and purchasing records; and
a manual database table for storing information such as general information about website, orders for the web server, introducing information about the learning/growing toy, the learning/growing toy itself, and information about interactions between the learning/growing toy and the user in the website.

13. The system of claim 1, wherein the web server comprises:
a banner database table for storing various items for satisfying the desires of the toy such as the desires for eating, learning, and playing, and advertising banners for the products of various companies according to the items; and
a goods information database table for storing detailed information included in the advertising banner stored in the banner database table, that is, barcodes of respective goods, reactions and style of action of the toy after recognizing the goods, reasons for generation of desires, the validity terms of the goods.

14. A learning/growing method of a toy using living goods comprising the steps of:
expressing desires;
inputting the outputted desires into a web server using a user computer;
downloading advertising banner goods for satisfying the desires in the user computer;
choosing the advertising banner by the user;
recognizing the results of banner choice of the user, and inputting the goods corresponding to the results into the toy through the user computer; and
teaching/growing the learning/growing toy by being inputted the goods.

15. A learning/growing method of a toy using living goods comprising the steps of:
expressing desires;
inputting the outputted desires into the web server;
downloading advertising banner goods for satisfying the desires in the user computer;
asking whether the user select the advertising banner goods or not;
choosing the advertising banner by the user, in case that the user wants to choose one;
waiting till the user chooses the advertising banner goods, in case that the user does not want to choose the advertising banner goods;
recognizing results of banner choice of the user, and inputting the goods corresponding to the results into the toy; and
teaching/growing the learning/growing toy by being inputted the goods.

16. The method of claim 15 further comprising a step of imitating motion, voice, or music corresponding to the advertising banner goods by the toy, in case that the learning/growing toy is inputted the advertising banner goods for satisfying the desires.

17. The method of claim 15, wherein the step of inputting the outputted desire into the web server includes a step of inputting the desires directly by the toy regularly or irregularly to the web server not by the user.

18. The method of claim 15, wherein the step of inputting the goods corresponding to the results of choices into the toy further comprises a step of inputting name or barcode of real goods by the user directly into the toy using the CCD camera or the barcode reader without using the user computer.

19. A learning/growing method of a toy using living goods comprising the steps of:
a first step in which a database storing goods information such as names or barcodes of the advertising banner goods, reactions and styles of action, reasons for desire generation, degrees of effects to the learning/growing is included in a web server, and the database is downloaded into the toy in order to teach/grow the toy;
a second step in which a desire is generated by the toy, after that the toy recognizes the corresponding goods by abstracting goods code from the name or barcode of the goods provided by the user, then identifies whether the goods code is in the database inside the web server; and
a third step in which the toy eats or gets the corresponding goods and respond corresponded to the goods if the recognized goods code is in the database.

20. The method of claim 19, wherein the database is updated continuously.

21. The method of claim 19, wherein the advertising banner goods in the database includes foods such as beverages, snacks, bread, and ice creams for satisfying the desire for eating.

22. The method of claim 19, wherein the advertising banner goods in the database includes banners such as academic institutes, and studying magazines for satisfying the desire for learning.

23. The method of claim 19, wherein the advertising banner goods in the database includes advertising banners such as parks, ba ll games, broadcasting programs, and toys for satisfying the desire for playing.

24. The method of claim 19, wherein the first step includes a step in which the toy connects to the web server by itself, chooses goods information list according to the tastes of the toy, and downloads the goods.

25. The method of claim 19, wherein the desires of the toy includes desires for eating, learning, and for playing.

26. The method of claim 19, wherein the first step includes a step of recording needed goods information in a storing medium such as a CD, and downloading it in the storing medium of the toy through the user computer.

27. The method of claim 19, wherein the first step includes a step of recording needed goods information in a storing medium of flash memory shape, and after that, storing the goods information in the storing medium of the toy using the flash memory.

28. The method of claim 19, wherein the desires of the toy are generated by the toy itself.

29. The method of claim 19, wherein the desires of the toy are generated in forms which are set by the database.

30. The method of claim 19, wherein the desires of the toy are generated as motion, letters, and sound forms.

31. The method of claim 19, wherein the desires of the toy are generated differently according to growing status of the toy.

32. The method of claim 19, wherein the names or barcodes of the goods in the second step are scanned by the CCD camera or by the barcode reader, and abstracted as goods codes.

33. The method of claim 19, wherein the third step further includes a step in which if the recognized goods code does not exist in the database, the goods is registered in a unregistered goods database, and then returned.

34. The method of claim 19, wherein the third step further includes a step in which the toy recognizes the goods, and after that controls parameters related to the learning/growing and grows.
